(19) United States
(12) Patent Application Publication
(10) Pub. No.: US 2020/0385291 A1
(43) Pub. Date: Dec. 10, 2020

(54) SELECTIVE BROMIDE ION REMOVAL AND RECOVERY BY ELECTROCHEMICAL DESALINATION

(71) Applicant: BAR-I LAN UNIVERSITY, Israel, Ramat Gan (IL)

(72) Inventors: Izaak COHEN, Ramat Gar (IL); Abraham SOFFER, Sarigim (IL); Doron AURBACH, Bnei Brak (IL)

(21) Appl. No.: 16/766,645

(22) PCT Filed: Nov. 22, 2018
(86) PCT No.: PCT/IB2018/059227

§ 371 Date: May 22, 2020

Related U.S. Application Data
(60) Provisional application No. 62/590,306, filed on Nov. 23, 2017.

(51) Int. Cl. C02F 1/469

(52) U.S. Cl. CPC C02F 1/4691; C02F 2101/12

(57) ABSTRACT

A method of bromide ion and iodide ion selective removal from seawater or the like by electrochemical desalination; and a device therefor. The method includes (a) providing a capacitive deionizing cell with high surface area activated carbon electrodes; (b) flowing the seawater through the cell; and (c) applying a voltage to charge and discharge the electrodes.

### FIELD OF THE INVENTION

The present invention relates to desalination, in particular a method and device/apparatus for selective removal of bromide ions from liquids such as sea water, brackish water, wastewater or the like.

### BACKGROUND OF THE INVENTION

Bromine has a variety of uses, such as in: fire extinguishers, agriculture and healthcare. The industrial waste of electric factories, bromine factories and hydraulic fracturing¹ contains a vast amount of bromide ions that could be recovered for reuse.

The removal and recovery of bromide ions have been researched in the past for environmental and economic purposes¹⁻⁴. The environmental aspect concerns potable water that contains traces of bromide ions, which could lead to by-products such as Trihalomethanes (THMs)^{3,5} and haloacetic acids⁶, as a result of chlorination; and bromate, as a result of ozonation^{7,8}. For at least these reasons, it is preferable to prevent bromide contamination of water reservoirs^{3,4} and/or remove bromide ions from already contaminated water sources^{1,2}. Regular desalination methods, such as reverse osmosis and direct distillation, require a significant amount of energy for the production of high pressures and temperatures, respectively, and do not selectively remove bromide. Previous efforts to selectively separate bromide used methods such as electro-oxidation of bromide ions¹⁻³ and ion exchange resins⁴, for selective removal of bromide ions from concentrated solutions and tap water.

Upon electro-oxidizing bromide ions (eq. 1), it is noticed that the electro-oxidation potentials of chloride ions and water (eq. 2, 3) are very close.

2Br⁻⇄Br+2e⁻E⁰=1.087 V (SHE) (1)

2Cl⁻⇄Cl_{2(aq)}+2e⁻E⁰=1.358 V (SHE) (2)

2H₂O⇄O_{2(aq)}+4e⁻+4H⁺E⁰=1.229 V (SHE) (3)

Sun et al¹, using graphite electrodes, achieved a specific electro-oxidation of bromide to bromine in a solution that contained various concentrations of chloride ions, and without generating chlorine or oxygen. However in that study, a KI solution was used to capture the released bromine gas, and the use of graphite required the use of a membrane to separate between the anode and the cathode; and the cathode (negative electrode) produced hydrogen.

It is believed that the technology relevant to the present invention is disclosed in:
(1) Sun, M.; Lowry, G. V.; Gregory, K. B. Selective Oxidation of Bromide in Wastewater Brines from Hydraulic Fracturing. Water Res. 2013, 47 (11), 3723-3731.
(2) Hayri Yalçin, Timur Koç, V. P. HYDROGEN AND BROMINE PRODUCTION FROM CONCENTRATED SEA-WATER. Int. J. Hydrogen Energy 1997, 22 (10-11), 967-970.
(3) Kimbrough, D. E.; Suffet, I. H. Electrochemical Removal of Bromide and Reduction of THM Formation Potential in Drinking Water. Water Res. 2002, 36 (19), 4902-4906.
(4) Lv, L.; Wang, Y.; Wei, M.; Cheng, J. Bromide Ion Removal from Contaminated Water by Calcined and Uncalcined MgAl—CO3 Layered Double Hydroxides. J. Hazard. Mater. 2008, 152 (3), 1130-1137.
(5) Magazinovic, R. S.; Nicholson, B. C.; Mulcahy, D. E.; Davey, D. E. Bromide Levels in Natural Waters: Its Relationship to Levels of Both Chloride and Total Dissolved Solids and the Implications for Water Treatment. Chemosphere 2004, 57 (4), 329-335.
(6) Heller-Grossman, L.; Manka, J.; Limoni-Relis, B.; Rebhun, M. Formation and Distribution of Haloacetic Acids, THM and TOX in Chlorination of Bromide-Rich Lake Water. Water Res. 1993, 27 (8), 1323-1331.
(7) Siddiqui Mohamed S., Amy Gary L., R. R. G. Bromate Ion Formation: A Critical Review. J. AWWA 1995, 87, 58-70.
(8) Krasner, S. T.; Glaze, W. H.; Weinberg, H. S. Formation and Control of Bromate During Ozonation of Waters Containing Bromide. J. AWWA 1993, 85 (1), 73.
(9) AlMarzooqi, F. a.; Al Ghaferi, A. a.; Saadat, I.; Hilal, N. Application of Capacitive Deionisation in Water Desalination: A Review. Desalination 2014, 342, 3-15.
(10) Porada, S.; Zhao, R.; van der Wal, a.; Presser, V.; Biesheuvel, P. M. Review on the Science and Technology of Water Desalination by Capacitive Deionization. Prog. Mater. Sci. 2013, 58 (8), 1388-1442.
(11) Oren, Y. Capacitive Deionization (CDI) for Desalination and Water Treatment—Past, Present and Future (a Review). Desalination 2008, 228 (1-3), 10-29.
(12) Gao, X.; Landon, J.; Neathery, J. K.; Liu, K. Modification of Carbon Xerogel Electrodes for More Efficient Asymmetric Capacitive Deionization. J. Electrochem. Soc. 2013, 160 (9), E106-E112.
(13) Omosebi, A.; Gao, X.; Landon, J.; Liu, K. Asymmetric Electrode Configuration for Enhanced Membrane Capacitive Deionization. ACS Appl. Mater. Interfaces 2014, 6 (15), 12640-12649.
(14) Lado, J. J.; Perez-Roa, R. E.; Wouters, J. J.; Isabel Tejedor-Tejedor, M.; Anderson, M. a. Evaluation of Operational Parameters for a Capacitive Deionization Reactor Employing Asymmetric Electrodes. Sep. Purif. Technol. 2014, 133, 236-245.
(15) Bianchini, R.; Chiappe, C. Stereoselectivity and Reversibility of Electrophilic Bromine Addition to Stilbenes in Chloroform: Influence of the Bromide-Tribromide-Pentabromide Equilibrium in the Counteranion of the Ionic Intermediates. J. Org. Chem. 1992, 57 (24), 6474-6478.
(16) Bellucci, G.; Roberto Bianchini, S.; Chiappe, C.; Ambrosetti, R. Formation of Pentabromide Ions from Bromine and Bromide in Moderate-Polarity Aprotic Solvents and Their Possible Involvement in the Product-Determining Step of Olefin Bromination. J. Am. Chem. SOC 1989, 1 (1), 199-202.
(17) Wang, T. X.; Kelley, M. D.; Cooper, J. N.; Beckwith, R. C.; Margerum, D. W.; June, R. Equilibrium Kinetic and Uv Spectral Charac of Aque Bromine Chloride-Bromine-and Chlorine Species. Inorg. Chem. 1994, 33 (25), 5872-5878.

### SUMMARY OF THE INVENTION

The present invention relates to an electro-chemical method of selectively removing bromide/bromine from a solution using high-surface area activated carbon and a relatively low electrical potential; and a device therefor.

The present electro-chemical method and device (asymmetrical capacitive deionization; A-CDI) can selectively remove bromine, in the form of bromide ions, from solutions containing other halide ions (halogen atoms), including chloride ions and/or iodide ions and/or fluoride ions, such as seawater, brackish water, wastewater or salt water and the like, that also may include nitrate, sulfate, carbonate and hydroxide ions, and the like. The aforementioned solutions shall be referred to hereinafter in the specification and claims, and with no limitation to be inferred, as “bromide-containing solutions” and derivatives of such terms/phrase. It should be understood that solutions such as seawater, brackish water and wastewater, and the like, may require pre-treatment before they are suitable as feed solutions in the present device and according to the present method.

In accordance with embodiments of one aspect of the present invention there is provided a method of selectively removing bromide ions from a bromide-containing solution by electrochemical desalination. The method includes: (a) providing an asymmetrical capacitive deionizing cell including high surface area activated carbon electrodes having an asymmetrical ratio of at least one positive electrode to at least one negative electrode; (b) flowing said bromide-containing solution through said cell; and (c) applying a voltage to the electrodes in an asymmetrical electrode ratio between the at least one positive electrode and the at least one negative electrode. Applying the voltage includes applying the voltage to charge and discharge the electrodes, including in a selective manner (ratios and choice of individual electrodes).

Although the term high surface area is well understood in this field, when required to provide clarity herein the specification and claims, the term will denote greater than 100 square meter square per gram of material.

In some embodiments, in step (c) the voltage is applied cyclically. In some embodiments, (c) includes applying a voltage lower than the SHE water electrolysis voltage.

In some embodiments, step (b) includes applying a voltage in the range of 0.5 to 1.0 Volts. In some embodiments, step (b) includes applying a voltage in the range of 0.8 to 1.0 Volts.

In some embodiments, in step (a) the surface area of the electrodes is in the range of 100 to 3,000 m²/gram. In some embodiments, in step (a) the voltage is applied in an asymmetrical electrode ratio range of 1:10 to 1:1. In some embodiments, in step (a) the voltage is applied in an asymmetrical electrode ratio range of 1:2 to 1:4.

In some embodiments, in step (c), applying the voltage includes polarizing the cell and producing a faradaic behavior on the surface of the at least one positive electrode and a capacitive behavior on the surface of the at least one negative electrode.

In some embodiments, the method further includes discharging the electrodes whereby the solution becomes concentrated and can be routed to a waste or exit stream. In some embodiments, the method further includes selectively removing iodide ions from the bromide-containing solution.

In some embodiments, voltage is applied to varied electrodes during operation of the cell to produce varied ratios of positive electrode(s) to negative electrode(s) and/or varied selection of which electrodes are positively charged and negatively charged.

In some embodiments, the method includes producing an electrical double layer that adsorbs counter-ions to the negative electrodes and an electrochemical redox reaction of bromide to bromine and vice versa on the surface of the relatively positive electrodes, thereby producing a diluted solution such that upon discharging of the electrodes the solution becomes concentrated and can be routed to a waste or exit stream.

Note that because during operation bromine molecules adsorb onto the electrodes, the device can alternatively be termed a hybrid physical adsorption and (asymmetrical) capacitive deionization (HPA/A-CDI) cell device, although for simplicity the abbreviation A-CDI and the related term will generally be used interchangeably.

As a result, from the bromide-containing solution (e.g. seawater and so on) there can be selectively produced (i) a relatively dilute solution with relatively lower quantities of one or more specific anions (e.g. bromide ions and/or iodide ions); and (ii) a relatively concentrated solution of specific anions (e.g. bromide ions and/or iodide ions).

In accordance with embodiments of another aspect of the present invention there is provided a device for selective bromide ion and iodine removal from a bromide-containing solution by electrochemical desalination. The A-CDI device includes: an asymmetrical capacitive deionization cell including high surface area electrodes, the capacitive deionization cell including: an upper cover; a current collector; at least one high surface area activated carbon negative electrode; a spacer; an electrode separator; at least one high surface area activated carbon positive electrode; a solution distributor; a bromide-containing solution inlet at the bottom of the A-CDI cell; a solution outlet at the top of the cell; and a bottom cover.

In some embodiments, the A-CDI cell is configured so that when polarized under a potential that mitigates water splitting, there is produced an electrical double layer that adsorbs counter-ions to the negative electrodes and an electrochemical redox reaction of bromide to bromine and vice versa that takes place at the positive electrodes, to produce a diluted solution such that upon discharging of the electrodes the solution becomes concentrated and can be routed to a waste or exit stream.

In some embodiments, the A-CDI cell is configured to direct the solution to flow through the electrodes. In some embodiments, the A-CDI cell is configured to direct the solution in a flow-by flow pattern.

In some embodiments, the solution distributor is configured to distribute solution to the periphery of the positive and negative electrodes.

In some embodiments, the surface area of the electrodes is in the range of 100 to 3,000 m²/gram.

In some embodiments, the electrodes are in an asymmetrical electrode ratio range of 1:10 to 1:1. In some embodiments, the electrodes are in an asymmetrical electrode ratio range of 1:2 to 1:4.

In some embodiments, the separator comprises a polyethylene cloth.

In some embodiments, the device is configured for the selective removal of iodide ions from the bromide-containing solution.

In some embodiments, the device is configured for the selective removal by adding membranes to the electrodes. In some embodiments, the device is configured for the selective removal of haloid ions by the addition of one or more ion exchange membranes and/or a diaphragm to the electrodes.

In accordance with embodiments the present invention the use of asymmetric cells for the asymmetric potential distribution avoids water splitting differential potential, or at least substantially mitigates water electrolysis, and enables the oxidation of bromide to bromine, which takes place at a relatively high potential (0.7-1.0 Volts).

In accordance with embodiments of another aspect of the present invention there is provided a use of an asymmetrical capacitive deionization cell for selective removal of bromide ions from a bromide-containing solution. In some embodiments, the use is for selective removal of iodide ions from the bromide-containing solution.

The method and device/apparatus uses activated carbon electrodes in an asymmetric cell configuration. To apply high potential on the positive electrodes and to avoid or at least substantially mitigate water electrolysis, the deviation in potential is divided asymmetrically, because of the deference in the surface area of the electrodes. The positive and negative electrodes that were used in the experiments described below were in a weight ratio of 1 to 5, respectively, and had the same type of activated carbon electrodes, with surface area of 1500 m²/gr (BET measurement). Hence, the positive electrodes used had a relatively low surface area, and the negative electrodes used had a relatively high surface area.

As a result, bromide ions can be removed and recovered preferentially to chloride ions and/or nitrate ions and/or sulfate ions and/or carbonate ions and/or hydroxide ions from bromide-containing solutions.

The present invention is based on the use of high surface area activated carbon electrodes, which is in contrast to current methods/apparatus that utilize graphite, titanium and metal alloys for the purpose of bromide removal by electro-oxidation.

During each cycle of charge and discharge by the present method/apparatus a certain portion of the bromide ions is selectively removed from the bromide-containing solution and then the removed bromide ions are (can be) transferred into a different solution for recovery. During the charging stage, the positively charged high surface area activated carbon electrodes electro-oxidize and physically adsorb bromine molecules and electrostatically adsorb bromide, tri-bromide and penta-bromide anions from the feed solution, whereby the (effluent) solution is (significantly) cleansed of bromide resulting in an essentially bromide-cleansed water effluent (solution with a diluted bromide content). After a significant amount of bromide ions are adsorbed onto the positively charged high surface area activated carbon electrodes, those electrodes are discharged to release the now reduced bromide ions that were adsorbed, which can go to a waste stream.

Unlike other systems, the present invention exclusively uses activated carbon electrodes (with high surface area) and low voltage to remove and restore bromide ions from the treated solution and back. The term “carbon” herein the specification and claims includes high surface area carbonaceous materials that might be suitable for the same purpose, such as graphene; graphene oxides; carbon nanotubes; and carbon dots, including combinations thereof that can be in various ratios and mixtures.

During the operation of charging and discharging of the electrodes, bromine and chlorine molecules are not respectively released to the bromide diluted solution or to the concentrated solution, and the resultant solution can achieve a significantly low quantity of bromate; even lower than 10 ppm.

The present invention provides a significant dilution of bromide ions from a solution containing bromide and chloride ions in same concentration, while charging the activated carbon electrodes. Likewise, there is also provided a significant bromide concentration rise in a solution that initially contained bromide and chloride ions in the same concentration, during the discharging of the activated carbon electrodes.

The use of low differential potentials of 0.5 to 1 Volt, leads to a substantial saving in electrical energy. Due to the use of asymmetric cells, the potential is divided asymmetrically and therefore the overall differential potentials required are lower than usual; hence, lower electrical energy is required.

It is a particular feature of the invention that the device is configured, and method includes the steps, wherein voltage can be applied to varied electrodes during operation of the A-CDI cell to produce varied ratios of positive electrode(s) to negative electrode(s) and/or varied choice of which electrodes are positively charged and negatively charged.

Thus, if for example, the A-CDI cell device has three cells, (a) the electrode of cell number one (i.e. the first electrode) be can be operated as a positive electrode and the second and third electrodes are negative electrodes; or (b) the second electrode can be operated as a positive electrode and the first and third are negative electrodes; or (c) the third electrode can be operated as a positive electrode and the first and second electrodes are negative electrodes; or (d) the first and second electrodes can be operated as positive electrodes and the third electrode is a negative electrode; or (e) the first and third electrodes can be operated as positive electrodes and the second electrode is a negative electrode; or (f) the second and third electrodes can be operated as positive electrodes and the first electrode is a negative electrode. Moreover, this “order” or sequence can be changed during operation. It should be understood that the options for similar permutations exist with any number of electrodes in the A-CDI device. The consequence of varying the number (and order/combination) of positive and negative electrodes is significant. Oxidation of the high surface area activated carbon electrodes can lead to their destruction by an oxidation reaction that produces CO2 or the like. Additionally, as the bromine molecules and bromide ions adsorb on surface area of the electrodes, the electrodes are not available for additional adsorption, reducing performance. The varying of charging/discharging alleviates both of these issues and greatly improves the long term stability of the electrodes.

### BRIEF DESCRIPTION OF THE DRAWINGS

The present invention will be understood and appreciated more fully from the following detailed description taken in conjunction with the appended drawings in which:

FIG. 1 is a perspective view of an asymmetrical capacitive deionization (A-CDI) cell device in accordance with embodiments of the present invention;

FIG. 2 is a schematic depiction of an experimental apparatus for evaluating the deionization cell device for separating bromide ions from an aqueous bromide-sodium chloride solution;

FIGS. 3-12 are graphical depictions of experimental results when operating the A-CDI cell device; and

FIG. 13 is an exploded perspective view of the present A-CDI device, and components thereof, in accordance with embodiments thereof.

The following detailed description of embodiments of the invention refers to the accompanying drawings referred to above. Dimensions of components and features shown in the figures are chosen for convenience or clarity of presentation and are not necessarily shown to scale. Further, terms relating to position/orientation such as upper, lower, top, bottom and the like should be understood to be replaceable when possible and for explanation purposes only. Wherever possible, the same reference numbers will be used throughout the drawings and the following description to refer to the same and like parts.

### DESCRIPTION OF EMBODIMENTS

Illustrative embodiments of the invention are described below. In the interest of clarity, not all features/components of an actual implementation are necessarily described. Embodiments and/or limitations featured in the figures are chosen for convenience or clarity of presentation and are not meant to limit the scope of the invention.

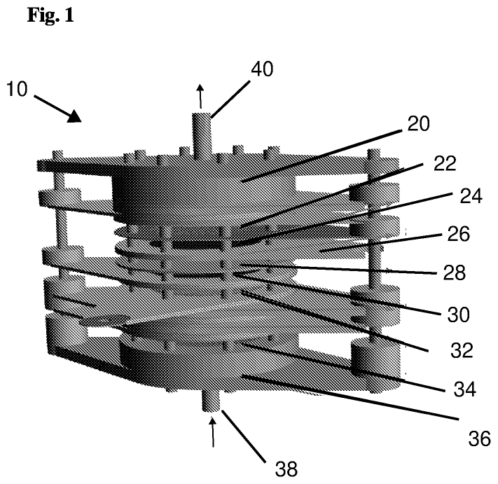

FIG. 1 shows an embodiment of an asymmetrical capacitive deionization cell device 10 (A-CDI) of the present invention; or “flow-through” asymmetric CDI cell.

The present invention uses Capacitive Deionization (CDI)—an energy efficient water desalination technology⁹⁻¹¹. CDI cells include high surface area electrodes, which are usually activated carbon materials, that when polarized under a potential lower than the water splitting potential (eq. 3), create an electrical double layer that adsorbs counter-ions to the high surface area of the electrodes to produce a diluted solution. When electrically discharged, the solution becomes concentrated and can be routed to a waste or exit stream.

FIG. 1 shows an exemplary A-CDI cell 10 that includes, in top down order of location, an upper cover 20 (e.g. made of PVC); a current collector 22; at least one activated carbon cloth “negative” electrode 24 (e.g. five electrodes as exemplified in FIG. 1); a spacer 26, e.g. made of polytetrafluorethylene (PTFE); an electrode separator 28 (separator plate/sheet/disc, e.g. polyethylene cloth); at least one activated carbon cloth “positive” electrode 30 (e.g. one electrode as exemplified in FIG. 1); a reference electrode (RE) 32 (e.g. an Ag/AgCl electrode); a solution distributor 34; and a bottom cover 36, (e.g. made of PVC). There is a bromide-containing solution inlet 38 at the bottom of the asymmetric CDI cell 10; and a solution outlet 40 at the top of the cell. The structure of A-CDI cell 10 is designed for flow-through flow of the solution and has a flange-type design (FIG. 1).

The present removal and recovery of bromide ions by electro-oxidation and electro-reduction uses Asymmetric CDI (A-CDI) cells, which in some embodiments contain Activated Carbon Cloth (ACC) as electrodes. A-CDI cells have been previously used to achieve better water desalination performances, as disclosed for example in Gao, X.; Landon, J.; Neathery, J. K.; Liu, K. Modification of Carbon Xerogel Electrodes for More Efficient Asymmetric Capacitive Deionization. J. Electrochem. Soc. 2013, 160 (9), E106-E112.]¹²⁻¹⁴.

In the present system/method, an A-CDI cell 10 is used to enable an electro-oxidation of bromide ions by applying a positive potential of approximately 1 Volt on the positive polarized electrodes (eq. 1). By the use of A-CDI cell 10, the electrolysis of water was prevented, or at least mitigated (eq. 3). A-CDI cells, configured in accordance with embodiments of the present invention, enable an asymmetric polarization of the electrodes, which means that the applied potential is divided between the positive and negative electrodes in an asymmetric way, where the higher potential falls on the positive electrodes (that have a relatively low surface area—due to a ratio of 1 to 3, 4 or 5 in favor to the negative electrodes, and the low potential falls on the negative electrodes (that have a relatively high surface area). CDI technology usually utilizes a low potential to enable only electrostatic adsorbtion of ions from a solution and not for electro-chemical reactions of the ions.

The highly non-polarized activated carbon exhibits high interaction with bromine molecules and thus is commonly used in industry. Upon electro-oxidizing the bromide ions to bromine, the bromine molecules are formed near the surface of the positive ACC electrode(s). Hence electro-oxidation encourages the bromine molecules to physically adsorb to the surface of the positive ACC electrodes. When discharging the electrodes, bromine molecules that are physically connected to the positive ACC electrodes are reduced back to bromide ions and go back in to the solution. The present invention provides a new application for the CDI technology and opens up the technology to new fields of research and applications.

### Experimental

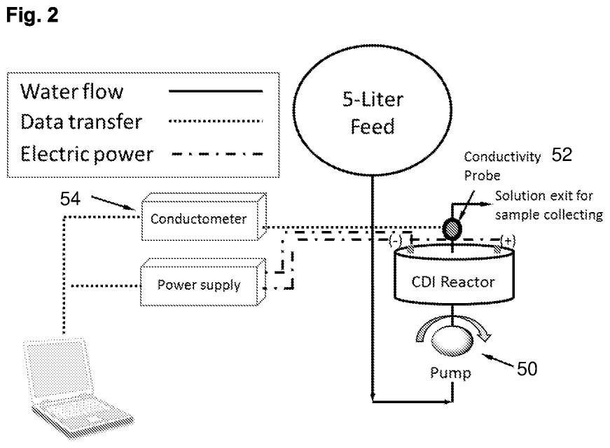

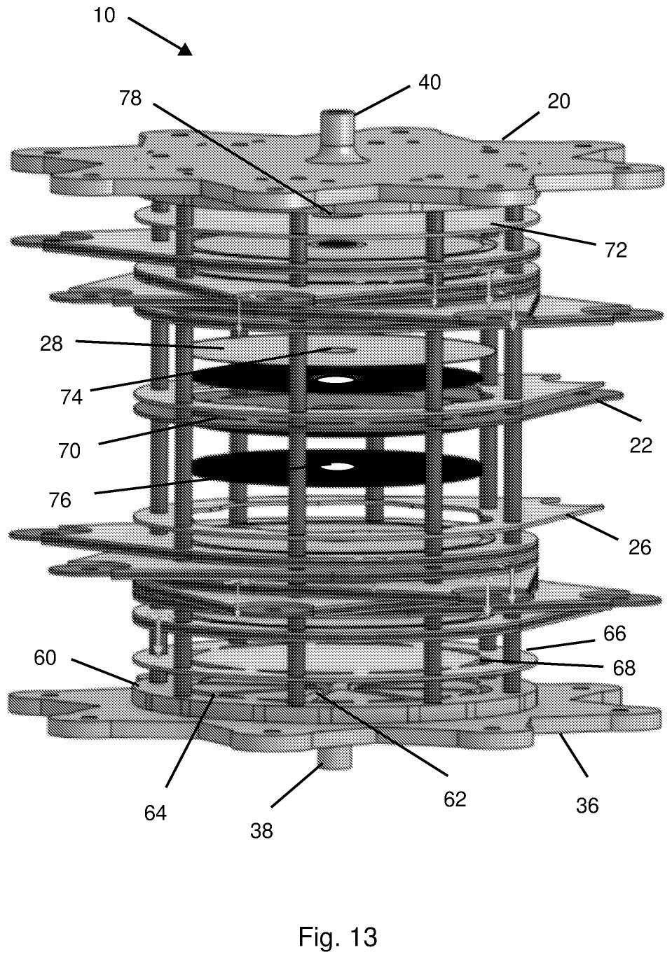

With reference to FIG. 2, a bromine/bromide ion containing NaCl-solution was flowed into the A-CDI cell 10. Plates or distributors, for example having a plurality of solution distributor outlets like a showerhead (not visible in FIG. 2; see FIG. 13 which illustrates an inlet solution flow-distributor 60 designed for a flow-by solution flow pattern), were used to help ensure homogeneous flow of the solution throughout the entire circular cross-section of the A-CDI cell 10. The A-CDI cell's electrodes 24, 30 were made of commercial activated carbon cloth (ACC-5092-15, Nippon Kynol, Japan) with a high surface area (1440 m²/g BET) originating from phenol-formaldehyde polymeric fibers that underwent carbonization and activation.

The A-CDI cell 10 contained twenty four ACC disc electrodes (twenty negative polarized electrodes and four positive polarized electrodes; a ratio of 5:1 in number, and also in surface area). The positive electrodes were used as Working Electrodes (WE) and the negative electrodes were used as Counter Electrodes (CE). Sheets/discs of porous polyethylene cloth served as separators 28 between the electrodes 24 and exhibited a fairly low resistance to the solution flow. Silicon glue was soaked into the perimeter of rims (not visible) of the electrode separators, forming soft and elastic gaskets. These sheets/discs of electrode separators 28 with their perimeter gaskets provided the necessary mechanical and electrical separation between the electrodes 24, 30 thereby preventing short circuits. The electrodes 24 were encased by plastic ring spacers (not visible), made of polytetrafluoroethylene (PTFE), with 0.5 mm and 2.5 mm deep grooves that respectively held the lone positive ACC carbon electrode 30 and the five negative ACC carbon electrodes 24. The current collectors 22 were made of graphite paper discs (Grafoil-Inc.) that were attached to the cell's electrodes 24, 30. The current collectors 22 were perforated to allow a smooth flow of solution. Reference electrode 32 was placed at the middle of the A-CDI cell 10. Reference electrode 32 was a silver mesh covered by AgCl, produced by anodization of the silver mesh in 0.1M HCl solution. When all the CDI cell components (the electrodes 24, 30 in their plastic cases; graphite sheet current collectors 22; and electrode separators 28 with polymeric gaskets at their perimeter) were all pressed together, in the right order, they form a hermetically sealed flow-through multi-electrode electrochemical cell that operated as three-electrode cells (reference electrode, working electrode and counter electrode).

### Experimental Apparatus Set-Up

FIG. 2 shows a schematic layout of an experimental apparatus for the capacitive deionization cell device/system, which was used for evaluation. A five liter round-bottom flask was used as the solution reservoir for the experimental system. The flask contained a five liter solution of 0.05M NaCl (>99.5% pure, Sigma-Aldrich, USA) and 0.05M NaBr (>99% pure, Strem Chemicals, USA), in highly purified water (18.2 MO). Prior to polarization of the CDI cell, the solution was circulated in a closed system. The apparatus/system included the electrochemical A-CDI cell 10 or reactor; a pump 50 (e.g. a peristaltic pump); and a conductivity probe 52 of a conductometer 54 (Metrohm conductometer model 712) for air evacuation, which was connected to the outlet of the A-CDI cell 10 to measure on-line the conductivity of the solution flowing out of the A-CDI cell. To control the solution flow, peristaltic pump 50 (Fluid Metering Inc.) was used and the solution flow was set to 8.5 ml/min. Potentials were applied to the A-CDI cell 10 by a potentiostat (Metrohm, Autolab, PGSTAT302N, not shown). When polarizing the A-CDI cell electrodes 24, 30, the system set-up, as shown in FIG. 2, was modified to an open system, where the solution exited from the system to provide for an analytical sampling.

### Analytic Tools

Samples were collected and measured by analytical tools for the quantitative evaluation of bromide; bromate; and chloride ions that were solvated inside each sample solution. Ion chromatography was carried out by 9×10⁻³ M of Na2CO3 (Dionex ICS-2100, Thermo Scientific) to separate and measure the weight of the different ions in the solution of each sample. Additionally, the weight of the ions was measured by titration with AgNO3 at concentration of 0.01 N (848 Titrino plus, Metrohm) to confirm and enable the evaluation of the different ions that were difficult to separate by Ion Chromatography.

### Results and Discussion

CDI technology is usually used for its capacitive electrostatic properties. To use CDI technology for electrochemical reactions with bromide ions and to avoid or at least substantially mitigate electrochemical reactions with chloride ions while using ACC electrodes, a preliminary study of the working potential domains was established.

Comparison Between Chloride/Chlorine and Bromide/Bromine Redox Reaction by Cyclic Voltammetry (CV) Using Potentials Lower than and Equal to 1 Volt

Two different solutions for Cyclic Voltammetry (CV) measurements were made: one solution contained 0.05 M of NaCl and the second solution contained 0.05 M of NaBr. The electrodes that were used for these three-electrode cells were a Saturated Calomel Electrode (SCE), as a reference electrode; a Working Electrode (WE) and a Counter Electrode (CE), the WE and CE both made from ACC (ACC-5092-15, Nippon Kynol, Japan), in a WE to CE weight and surface area ratio of 1:10.

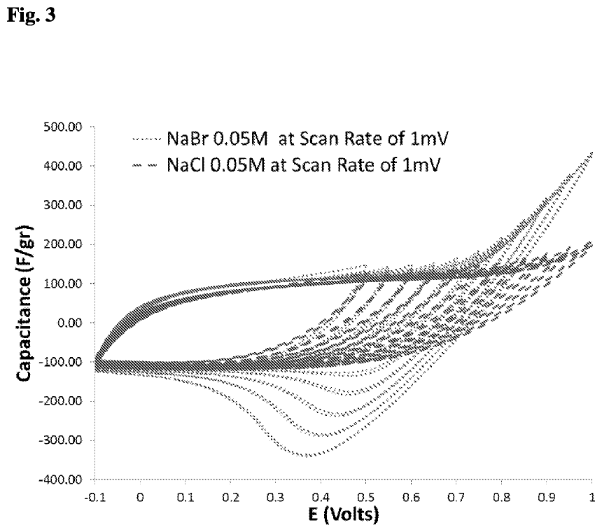

FIG. 3 shows a plot of the Capacitance to Voltage results that were made by CV, where the X-axis is the potential that was measured between the reference electrode and the working electrode (in Volts, with reference to a Hg/HgCl saturated electrode) and the Y-axis is the capacitance (in F/gr). The scan rate was 1 mV/sec, the lower vortex potential was −0.1 V (for all the CV measurements), and the upper vortex potentials of all the CV measurements were applied in progressive 0.05V increments from 0.5V to 1V. The concentrations of the NaCl and NaBr solutions were 0.05 M.

The CV measurement was repeated twice for every upper and lower vortex potential. The results clearly show that the chloride ions preserved almost the same electrostatic capacitive behavior, even when the upper vortex applied potential was 1 Volt. In contrast, a redox reaction is seen clearly by the CV plot, where the bromide ions are oxidized to bromine and reduced back to bromide ions, starting from the potential of 0.8 V, and reached higher bromide/bromine redox interaction as the applied upper vortex potential increased.

The high peak of the anodic oxidation indicates that there are also irreversible reactions like water splitting (electrolysis), which is also indicated by the NaCl high potential CVs. The measurement was repeated twice for each voltage scan range (FIG. 3) and showed reversible redox reactions, which confirmed the reversibility of the bromide ions to bromine and vice versa.

The NaCl preserved a capacitive behavior even at a high potential of 1 Volt, where a minimal water electrolysis reaction can be seen. On the other hand, the NaBr preserved its capacitive behavior until the high vortex potential increased beyond the potential of 0.8 Volts and the behavior became an electrochemical redox behavior.

From FIG. 3 it can be understood that a usable range of oxidation potential for the separation of bromide from chloride in the bromide containing solution is approximately 0.7 V to 1.0 V. However, it should be understood that at the lower end of that range (0.7 V) there is a tendency for a lower bromide ion separation capability. Also if a voltage above 1.0 V, e.g. 1.1 V, is used, then the removal capability will be greater, however at the expense of the stability of the activated carbon electrodes and the separation ratio between bromide and chloride might be affected. Thus, a range of 0.7-1.1 voltages is considered usable, more preferably 0.8-1.0 V and even more preferably 0.9-1.0V. FIG. 3 also indicates a usable reduction potential range of 0.0-0.7 V, more preferably in the reduction potential range of 0.2-0.5 V.

### Determining the Redox Working Potential Domain of Bromine/Bromide by Cyclic Voltammetry (CV)

To determine the redox working potential domain, a solution of NaCl and NaBr in respective concentrations of 0.05M and 0.005M was used, where the NaCl salt was used as a supporting electrolyte, which was based on the knowledge acquired by the previous results (FIG. 3) that show CVs of chloride ions in a capacitive behavior when using potentials lower and equal to 1 Volt. The results were obtained using the same three-electrode cell as above, with pristine electrodes.

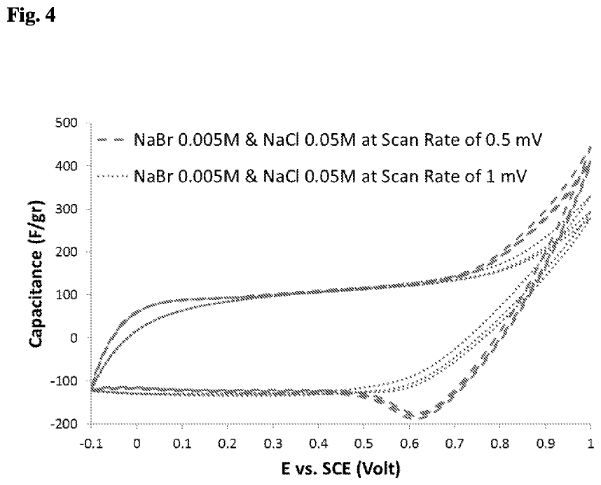

FIG. 4 shows plots of Cyclic Voltammetry (CV) results for scan rates of 1 mV/sec and 0.5 mV/sec of a mixed solution of NaCl and NaBr in concentrations of 0.05M and 0.005M, in a three-electrode system, where the NaCl salt was used as a supporting electrolyte. The Y-axis represents the capacitance (F/gr) and the X-axis represents the applied potential in reference to a Hg/HgCl standard electrode. To focus on the redox reactions, whose beginning and end is unclear (FIG. 3), a smaller amount of bromide electrolyte was used; and to avoid the IR drop, a supporting electrolyte of NaCl was used. A scan rate of 1 mV/sec for the low concentration of NaBr was too fast for the diffusion kinetics of the low concentration of bromide ions, which is why the plot indicates a capacitive behavior. When using a slower scan rate of 0.5 mV/sec, the plot shows a capacitive behavior between the potentials of −0.1V and 0.5V, and an electrochemical redox behavior between the potentials of 0.5V and 1V.

The 1 mV/sec scan rate preserved the capacitive behavior at the cathodic side, and at high potentials had an oxidation peak in the anodic polarization. The 0.5 mV/sec scan rate preserved a capacitive behavior between −0.1 and 0.5 Volts, and indicated a reasonable working potential range for the redox electrochemical reaction of 0.5 to 1 Volts.

From FIG. 4 it can also be understood that a usable range of reduction potential for the separation of bromide from chloride in the bromide containing solution is approximately 0.5 V to 0.75 V, preferably 0.5-0.6V, due to improved recovery of bromide in the cyclical redox operation/process.

### Selective Removal of Bromide, by a Flow-Through Asymmetric CDI Cell

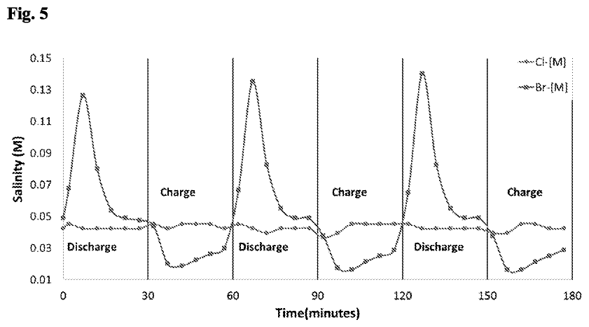

After verifying the working potential range, selective desalination of bromide was carried out. The solution was flowed through an A-CDI cell with pristine ACC electrodes with a negative to positive electrode weight (and surface area) ratio of 5:1, and the solution contained bromide and chloride ions, both at a concentration of 0.05M. FIG. 5 shows three cycles of selective removal and recovery of bromide ions from a solution that contained the same concentrations of chloride and bromide ions. Samples from the three cycles were taken after two preliminary cycles were carried out to achieve a proper operation of the electrodes inside the A-CDI cell. The three cycles repeated themselves with a moderate rise in the removal and recovery capability of bromide ions, which can be explained by traces of air that were trapped inside the ACC micro pores, after the preliminary cycles. The removal and recovery of the bromide ions were dominant; and the removal and recovery of the chloride ions were so low that the change in the concentrations fitted the analytical tool's percentage error. Hence a selective removal of bromide ions was achieved. Furthermore, all the measured samples showed that the concentration of the bromate ions was less than 10 PPM.

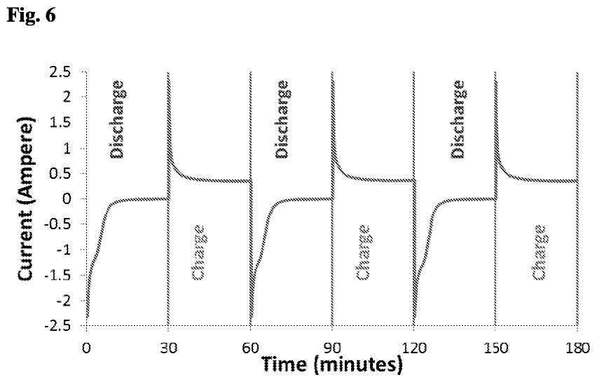

FIG. 6 shows a plot of current versus time of the results shown in FIG. 5. The three cycles shown in FIG. 6 repeat themselves, which again indicates reproducible results from an electric charge aspect. Based on the integral of the current, the overall charges that were used for each cycle charge and discharge were calculated.

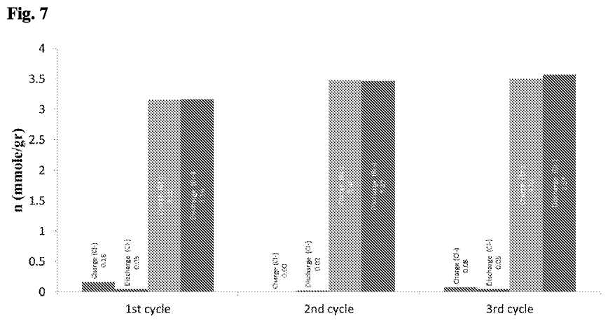

FIG. 7 is a chart displaying calculations from the results shown in FIG. 5. FIG. 7 shows a comparison between the three cycles by the accumulated quantity of anions (bromide and chloride ions) that were adsorbed/desorbed by the A-CDI cell. The Y-axis represents the quantity of bromide and chloride ions that were removed and recovered in mmoles and normalized by the ACC working electrodes total weight, which was 1.7 grams. The chart shows that the accumulated removal and recovery of bromide ions in each cycle were almost the same. Hence almost all of the bromide ions that were adsorbed and electro-oxidized into bromine inside the porous structure of the ACC electrodes while polarizing to a potential of 1 Volt were electrochemically reduced back into the solution as bromide ions, when the ACC electrodes were polarized back to a lower potential of 0.5 Volts. Based on the obtained results, when comparing the incremental removal and recovery of the bromide and chloride ions, the bromide ion removal and recovery was almost two orders of magnitude larger than that of the chloride ions, confirming selective desalination of bromide ions from a solution that contains chloride ions.

When working in a capacitive mode, the capacitance of a 1 gram ACC electrode was calculated to be about 100 F/gram. When translated to the quantity of salt removal, the maximum capability (dividing by Faraday's constant) equals about 1 mmole. In the present experimentation, the theoretical maximal desalination capability increased by 3.5-fold, which was the actual removal capability, and probably not the maximal.

Without limitation to theory, it was considered that upon polarizing the ACC electrodes to 1 Volt, the bromide ions were electro-oxidized to bromine. Bromine molecules have a strong physical affinity to activated carbon and the bromine molecules are produced inside the micro-porous structure of the ACC, which reduces the movement of bromine molecules back into the solution. Meanwhile, other bromide ions, which are electrostatically adsorbed onto the ACC's pores and get electro-oxidized, interact with the bromine molecules to produce Tribromide ions and Pentabromide ions, as illustrated by equations 4-6:

$$\begin{matrix}{Br}^{-} + {Br}_{2} \begin{matrix}{\to }^{{k}_{1}} \\ ←\end{matrix} {Br}_{3}^{-} & ( 4 ) \\ {Br}^{-} + 2 {Br}_{2} \begin{matrix}{\to }^{{k}_{2}} \\ ←\end{matrix} {Br}_{5}^{-} & ( 5 ) \\ {Br}_{3}^{-} + {Br}_{2} \begin{matrix}{\to }^{{k}_{3}} \\ ←\end{matrix} {Br}_{5}^{-} & ( 6 )\end{matrix}$$

The slow reduction of the bromine to bromide ions, as seen in FIG. 3, can be understood with consideration of bromide, tribromide and pentabromide equilibrium, as investigated in the past¹⁵⁻¹⁷. The slow reduction occurs due to the slow kinetics of the intermediate molecular reactions that ultimately produce bromide ions.

The energy required for the removal and recovery of bromide ions (J/gr) from a solution of NaCl and NaBr, both in concentration of 0.05M, was calculated using equation 7:

$${E}_{( J )} = \frac{{E}_{( V )} \cdot \int I dt}{n \cdot {M}_{w}} \qquad ( 7 )$$

Where E_{(J)} is the energy used for the removal and recovery of 1 gram of bromide ions; E_{(V)} is the potential used for the electro-oxidation of bromide ions to bromine; ∫Idt is the charge used for the removal of bromide ions; n is the number of moles of bromide ions that were removed; and M_{w} is the molar mass (molecular weight) of the bromide ions. The energy consumption for the removal and recovery of 1 gram bromide ions was calculated to be about 2.24 KJ/gr, which is two orders of magnitude less than the energy consumption of standard CDI, which is 412 KJ/gr¹.

FIG. 5 shows a plot of salinity of NaCl and NaBr mixed solution in molar units vs. time in minutes, measured during the last 3 out of 5 cycles of operation by an A-CDI cell. The results were analyzed using samples that were taken at 5 minute intervals, at the solution outlet of the A-CDI cell. The plot shows a selective removal and recovery of bromide ions from a mixed solution that initially contained the same concentration of chloride ions. The samples of the three cycles were taken after two preliminary cycles that were carried out to achieve a proper operation of the electrodes inside the A-CDI cell.

FIG. 6 is a current versus time plot of NaCl and NaBr mixed solution, where both concentrations were 0.05M, measured during the last 3 out of 5 cycles of operation by the A-CDI cell. The 3 cycles repeat themselves, which indicates the repeatability of the results from the electric charge aspect.

FIG. 7. Is a column chart of the accumulated amount of bromide and chloride ions removed and recovered in mmole units, and normalized by the total weight of the ACC working electrodes, during the last 3 out of 5 cycles of operation by the A-CDI cell. The chart shows that the accumulated removal and recovery of bromide ions in each cycle were almost the same, and the removal and recovery of the bromide ions was almost two orders of magnitude larger than that of the chloride ions.

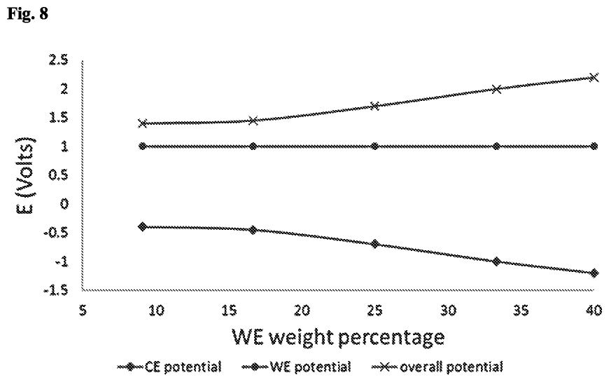

FIG. 8 helps in understanding the effect of the asymmetry of the surface area of the electrodes (via weight percentage difference between the Working Electrode (WE) and the Counter Electrode (CE) on the distributed potential. In other words, understanding the distributed potential and overall potential dependence on the WE weight percentage relative to CE.

Because a faradaic reaction is involved, it is difficult to predict theoretically how the potential is divided. An experiment was conducted using a two-channel potentiostat. One channel was operated by three electrodes and performed Cyclic Voltammetry (CV) measurements, and the second channel, was used to measure the potential change between the CE and the RE electrode of the same three-electrode cell, by an open circuit (OCV) measurement. A potentiostat was used for the OCV because of the high impedance of the instrument.

In this experiment, Kynol ACC-5092-15 electrodes were used in different weight ratios between the WE and the CE. The solution used contained 0.05M of NaCl as a background salt and 0.005M of NaBr. The scan rates were 0.5 mV/sec and the reference electrode (RE) was SCE.

CVs that were obtained for the WE and the CE, by comparing the times that were measured in both channels, were used to produce FIG. 8. The graph shown in FIG. 8 is based on Cyclic Voltammetry of CE and WE ACC-5092-15 electrodes against the SCE RE, using different ratios of surface area between the WE and the CE, in a solution of 0.05M of NaCl as a background salt and 0.005M of NaBr. The scan rates were 0.5 mV/sec. The WE was connected with the CE and the RE to one channel of the Potentiostat for CV measurements, while the second channel measured the open circuit potential between the RE and CE to produce a second CV measurement of the CE. The effect of the weight ratio (i.e. surface area ratio) between the electrodes is evident. When the weight ratio of the WE to the CE is higher (e.g. 40%—at the right side of the graph) a higher overall potential (between the CE and the WE) is required. At lower WE to CE ratios (i.e. higher surface area ratios) the required overall potential is lower (preferable).

In FIG. 8, the x-axis indicates the distributed potentials and overall potentials that were applied between the: WE and RE (distributed potential); CE and RE (distributed potential); and WE and CE (overall). The Y-axis indicates the weight percentage of the WE at each experimental measurement. The weight percentages were calculated by:

W_{WE}=(G_{WE}/(G_{CE}+G_{WE}))·100

Where W_{WE} is the WE weight percentage; G_{WE} is the weight of the WE; and G_{CE} is the weight of the CE.

FIG. 9 shows a redox reaction obtained using a lower surface area electrode. Carbon aerogel was used as the working electrode and counter electrode in a three-electrode system, and the surface area of each electrode was about 500 m²/gr. The RE was a Saturated Calomel Electrode (SCE) and the potential scan rate was 1 mV/sec from −0.1 to 0.9 Volts. The solution contained 0.05M of sodium bromide. It can be seen that even when using a lower surface area electrode (500 m²/gr compared to 1500 m²/gr) a redox reaction from bromide to bromine and vice versa is obtained. Additionally another carbon (carbon aerogel) was used, illustrating that other types of carbonaceous materials can produce similar results; i.e. that the phenomenon is not limited to carbon type.

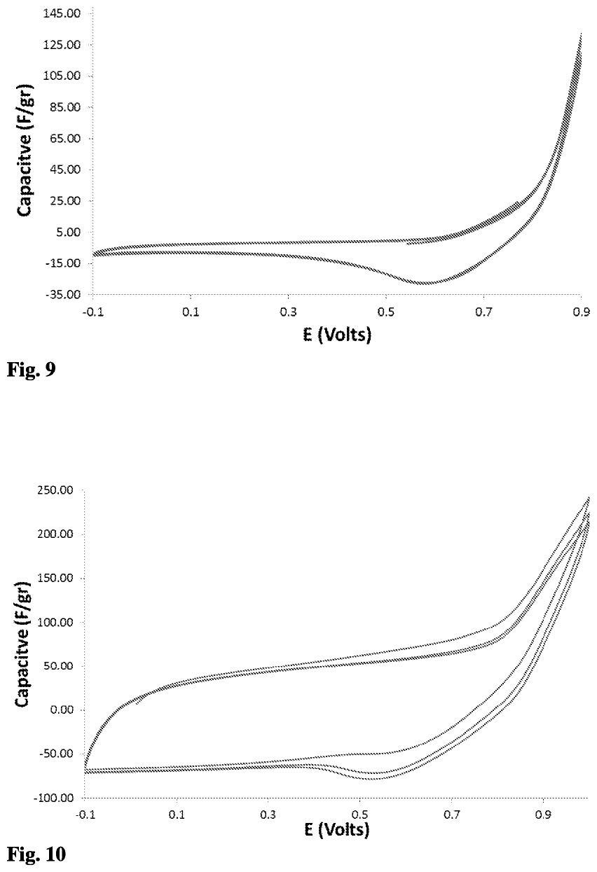

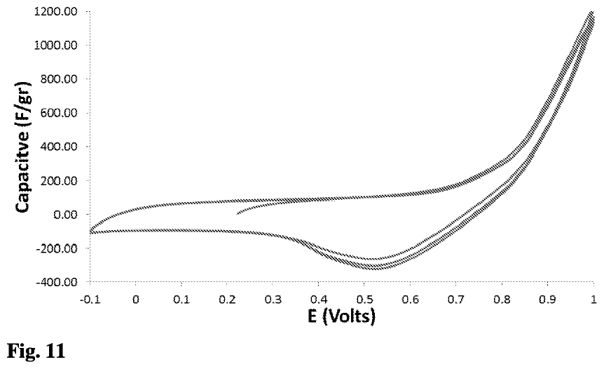

FIGS. 10 and 11 show the performance of other activated carbon electrodes. The results shown in FIG. 10 were obtained using three-electrodes where the WE and CE were YP-50F activated carbon electrodes with a surface area of 1500 m²/gr (Sanwa Components, USA) that had been produced by a mixture of YP-50F activated carbon powder (85%), polytetrafluoroethylene binder (10%) and carbon black (5%). The RE was SCE and the potential scan rate was 1 mV/sec from −0.1 to 1 Volts. The solution contained 0.05M of sodium bromide. FIG. 10 shows that when using a different carbon electrode, such as YP-50 activated carbon, with approximately 1500 m²/gr surface area, a redox reaction from bromide to bromine and vice versa is obtained.

The results shown in FIG. 11 were obtained using three-electrodes, where the WE and CE were Energy2 30-30 activated carbon (EnerG, USA) electrodes that had been produced by a mixture of Energy2 30-30 activated carbon powder (85%), PTFE binder (10%) and carbon black (5%). The RE was SCE and the potential scan rate was 0.1 mV/sec from −0.1 to 1 Volts. The solution contained 0.05M of sodium bromide. FIG. 11 shows that also when using a different carbon electrode such as Energy2 30-30 activated carbon, with 1500 m²/gr surface area, a redox reaction from bromide to bromine and vice versa is obtained.

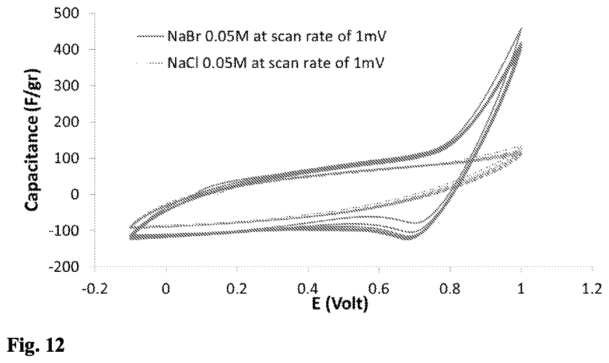

FIG. 12 shows a plot of the Capacitance to Voltage results that were made by CV, where the X-axis is the potential that was measured between the reference electrode and the working electrode (in Volts, with reference to a Hg/HgCl saturated electrode) and the Y-axis is the capacitance (in F/gr). The scan rate was 1 mV/sec, the lower vortex potential was −0.1 V (for all the CV measurements), and the upper vortex was 1V. The concentrations of the NaCl and NaBr solutions were 0.05 M. In this experiment, Kynol ACC-5092-15 electrodes were used as the working electrode and counter electrode in a weight ratio of around 1 to 10, respectively. The working electrode was sealed between a graphite paper (Grafoil-Inc.) as a current collector; PTFE (Polytetrafluoroethylene) was used as a spacer (as a frame for the ACC); and there was an anion exchange membrane at the top. FIG. 12 shows the electro-redox behavior of an A-CDI cell when used with a membrane (known as MCDI). Based on the CV plot, an electro-oxidation was obtained between 0.8 and 1 Volts, and electro-reduction was obtained between 0.8 to 0.6 Volts. The addition of the membrane can enhance the specific separation between the haloid ions and long term stability.

### Initial Conclusions

Removal and recovery of bromide ions by electro-oxidation and electro-reduction is viable using A-CDI cells, which contain Activated Carbon Cloth (ACC) as electrodes. The A-CDI cells enabled an electro-oxidation of bromide ions by applying a positive potential of about 1 V on the positive polarized electrodes (eq. 1) and avoiding or at least substantially mitigating electrolysis of the water (in some embodiments, by applying a potential lower than 1.229 V). A-CDI cells enabled an asymmetric polarization of the electrodes, which means the applied potential was divided between the positive and negative electrodes in an asymmetric way, where the high potential falls on the positive electrodes (that have a relatively low surface area) and the low potential falls on the negative electrodes (that have a relatively high surface area).

A redox reaction is clearly seen in the Cyclic Voltammetry plot (FIG. 3), when the bromide ions are oxidized to bromine and reduced back to bromide ions. In contrast, it can be clearly seen by the results that the chloride ions preserved almost the same electrostatic capacitive behavior, even when the upper vortex applied potential was 1 Volt.

Based on the results obtained, when comparing the bromide and chloride ions, incremental removal and recovery of bromide ion desalination capability is almost two orders of magnitude larger than that of chloride ions, indicating selective desalination of bromide ions from a solution containing chloride ions (see FIG. 7 illustrating accumulative bromide ions that were selective removed per cycle of charge and discharge). Additionally, the results indicate that the quantity of bromide ions that were removed and recovered were almost the same, which means that it is a reversible process. The high removal capability was explained by the high physical adsorption of bromine to activated carbon and, likely, by the conversion of bromide ions into tribromide and pentabromide structures.

The obtained results also showed a separation factor of about 70 times, in favor of bromide ions versus chloride ions (theoretically, there is a separation factor about 10,000 based on the Nernst equation); removal and recovery capability of 3.5 mmole of bromide ions by 1 gram of ACC WE; and the energy consumption for the removal and recovery of 1 gram bromide ions was calculated to be about 2.24 KJ/gr. The experiments described herein provide a starting point for optimization research of the A-CDI method by the usage of different concentrations of electrolytes and various activated carbon electrodes when using different flow regimes and flow rates. The present invention provides a new application/use for CU technology and opens the technology to new fields of research.

The invention is also suited for the separation/removal and recovery of iodide ions from bromide ions and chloride ions, including nitrate, sulfate, carbonate and hydroxide ions, and the like, for reasons similar to those shown above with regard to chlorine and bromine, in consideration of the low Iodine redox potential, as follows:

I₂+2e=2I⁻0.5355 V (SHE) (8)

I₃⁻+3e=3I⁻0.536 V (SHE) (9)

FIG. 13 shows the A-CDI cell device 10 in accordance with some embodiments, wherein the device is configured to provide a flow-by solution flow pattern, rather than a flow-through pattern. Such a flow pattern can result in lower pressure drop of solution flow through the device 10 in particular in tall stacks of cell components, as may be industrially/commercially advantageous.

The flow-by A-CDI cell device 10 is constructed similarly to the flow-through cell device, however there is an inlet solution flow-distributor 60 (distributor plate; in place of solution distributer 34) that distributes solution to the periphery of the electrodes 24, 30 rather than simply to the lower surfaces thereof, as in the flow-through pattern. To effect a flow-by flow pattern, the inlet solution flow-distributor 60 includes a radial pathways or channels 62 that receive the feed solution from bromide-containing solution inlet 38 and distribute the solution to the radial/distal ends of corresponding peripheral solution path recesses 64, Above flow-distributor 60 is a flow distribution mask 66 having peripheral solution path openings 68 corresponding to recesses 64. There is a flow distribution mask 66 with its peripheral solution path openings 68 to feed (flow solution to) all of the sets of electrodes 24, 30. Each one of the current collectors 22 also includes analogous peripheral solution path openings 70. At the top of the stack of cells is a solution flow mask 72 to help prevent leakage and direct the outward flow to solution outlet 40. Electrode separators 28 have central separator solution path through-holes 74 and electrodes 24, 30 have central electrode solution path through-holes 76, as does solution flow mask 72 (solution flow mask through-hole 78) where-through the solution flows upward.

As a result, the flow pattern is as follows: solution feed entering inlet 38 is distributed via flow-distributor 60 radially outward along channels 62 directing the flow to peripheral solution path recess 64; the solution then flows upward (downward if the device was upside-down) through peripheral solution path openings 68, 70 and 72. The solution then enters the electrodes 24, 30 at peripheral portions thereof and flows inwardly there-through to the central solution path through-holes 74, 76 and 78; and then exits via outlet 40.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A method of selectively removing bromide ions from a bromide-containing solution by electrochemical desalination, the method comprising:
a) providing an asymmetrical capacitive deionizing cell including high surface area activated carbon electrodes having an asymmetrical ratio of at least one positive electrode to at least one negative electrode;
b) flowing said bromide-containing solution through said cell; and
c) applying a voltage to the electrodes in an asymmetrical electrode ratio
between the at least one positive electrode and the at least one negative electrode.

2. The method of claim 1, wherein in step (c) the voltage is applied cyclically.

3. The method of claim 1, wherein step (c) includes applying a voltage lower than the SHE water electrolysis voltage.

4. The method of claim 1, wherein step (b) includes applying a voltage in the range of 0.5 to 1.0 Volts.

5. The method of claim 3, wherein step (b) includes applying a voltage in the range of 0.8 to 1.0 Volts.

6. The method of claim 1, wherein in step (a) the surface area of the electrodes is in the range of 100 to 3,000 m2/gram.

7. The method of claim 1, wherein in step (a) the voltage is applied in an asymmetrical electrode ratio range of 1:10 to 1:1.

8. The method of claim 1, wherein in step (a) the voltage is applied in an asymmetrical electrode ratio range of 1:2 to 1:4.

9. The method of claim 1, wherein in step (c), applying the voltage includes polarizing the cell and producing a faradaic behavior on the surface of the at least one positive electrode and a capacitive behavior on the surface of the at least one negative electrode.

10. The method of claim 9, further comprising discharging the electrodes whereby the solution becomes concentrated and can be routed to a waste or exit stream.

11. The method of claim 1, further comprising selectively removing iodide ions from the bromide-containing solution.

12. The method of claim 1, wherein voltage is applied to varied electrodes during operation of the cell to produce varied ratios of positive electrode(s) to negative electrode(s) and/or varied selection of which electrodes are positively charged and negatively charged.

13. The method of claim 1, comprising producing an electrical double layer that adsorbs counter-ions to the negative electrodes and an electrochemical redox reaction of bromide to bromine and vice versa on the surface of the relatively positive electrodes, thereby producing a diluted solution such that upon discharging of the electrodes the solution becomes concentrated and can be routed to a waste or exit stream.

14. A device for selective bromide ion removal from a bromide containing solution by electrochemical desalination, the device comprising:
an asymmetrical capacitive deionization cell including high surface area electrodes, the capacitive deionization cell comprising:
an upper cover;
a current collector;
at least one high surface area activated carbon negative electrode;
a spacer;
an electrode separator;
at least one high surface area activated carbon positive electrode;
a solution distributor;
a bromide-containing solution inlet at the bottom of the A-CDI cell;
a solution outlet at the top of the cell; and
a bottom cover.

15. The device of claim 14, wherein the A-CDI cell is configured so that when polarized under a potential that mitigates water splitting, there is produced an electrical double layer that adsorbs counter-ions to the negative electrodes and an electrochemical redox reaction of bromide to bromine and vice versa that takes place at the positive electrodes, to produce a diluted solution such that upon discharging of the electrodes the solution becomes concentrated and can be routed to a waste or exit stream.

16. The device of claim 14, wherein the A-CDI cell is configured to direct the solution to flow through the electrodes.

17. The device of claim 14, wherein the A-CDT cell is configured to direct the solution in a flow-by flow pattern.

18. The device of claim 17, wherein the solution distributor is configured to distribute solution to the periphery of the positive and negative electrodes.

19. The device of claim 14, wherein the surface area of the electrodes is in the range of 100 to 3,000 m2/gram.

20. The device of claim 14, wherein the electrodes are in an asymmetrical electrode ratio range of 1:10 to 1:1.

21. The device of claim 14, wherein in the electrodes are in an asymmetrical electrode ratio range of 1:2 to 1:4.

22. The device of claim 14, wherein the separator comprises a s polyethylene cloth.

23. The device of claim 14, further configured for the selective removal of iodide ions from the bromide-containing solution.

24. The device of claim 14, further configured for the selective removal by adding membranes to the electrodes.

25. The device of claim 14, further configured for the selective removal of haloid ions by the addition of one or more ion exchange membranes and/or a diaphragm to the electrodes.

26. Use of an asymmetrical capacitive deionization cell for selective removal of bromide ions from a bromide-containing solution.

27. The use of claim 26, further used for selective removal of iodide ions from the bromide-containing solution.
